(19) United States
(12) Patent Application Publication
(10) Pub. No.: US 2022/0210281 A1
(43) Pub. Date: Jun. 30, 2022

(54) DOCUMENT PROCESSING DEVICE AND INTUITIVE OPERATION METHOD THEREOF

(71) Applicant: AVISION INC., Hsinchu (TW)

(72) Inventor: CHUN-CHIEH LIAO, Hsinchu (TW)

(21) Appl. No.: 17/565,392

(22) Filed: Dec. 29, 2021

(30) Foreign Application Priority Data
Dec. 31, 2020 (TW) 109147120

(51) Int. Cl. H04N 1/00; H04N 1/04

(52) U.S. Cl. CPC H04N 1/00474; H04N 1/00488; H04N 1/0049; H04N 1/04; H04N 1/00384; H04N 1/00689; H04N 1/00411

(57) ABSTRACT

A document processing device comprises an input module used to obtain paper feed information, a human-computer interaction interface and a processor. The processor is connected to the input module and the human-computer interaction interface and drives the human-computer interaction interface according to the paper feed information, so that the human-computer interaction interface provides interactive prompt information. The processor executes a document processing mode according to command information after the human-computer interaction interface received the command information. Thereby, the document processing device can provide the interactive prompt information in real time according to the paper feed information, prompt a user to perform corresponding operations and achieve the purpose of improving operational efficiency and ease of use of the document processing device.

### CROSS-REFERENCE TO RELATED APPLICATION

This non-provisional application claims priority under 35 U.S.C. § 119(a) on Patent Application No(s). 109147120 filed in Taiwan, R.O.C. on Dec. 31, 2020, the entire contents of which are hereby incorporated by reference.

### BACKGROUND OF THE INVENTION

### 1. Field of the Invention

The present disclosure relates to a document processing device, and in particular to a document processing device with an intuitive operation method and the intuitive operation method thereof.

### 2. Description of the Related Art

A document processing device (e.g., an office equipment) in the state of the art usually has an automatic document feeder (ADF) and an operation interface (e.g., display panel, touch panel, etc.), when the user wants to scan and/or scan printing operations, a processing mode needs to be first set on the operation interface, and then places a piece of paper on the automatic document feeder, or places the paper before setting. After the above two steps are completed, the user has to press a start-up button on the operation interface, and then the document processing device performs actions of scan and/or scan printing according to the processing mode.

However, in the state of the art, regardless of two conditions of placing the paper after setting or placing the paper before setting, the user needs to set up on the operation panel, but because functions of the current document processing device are multiple and complicated, it often makes the user fail to know how to set the operator panel, or after the user spent time studying the operation method, the use found the setting error and needs to re-operate the operation panel, so the operation method in the state of the art is not friendly to the user and relatively inefficient. Therefore, how to improve the above-mentioned problems indeed needs to further propose improvements.

### BRIEF SUMMARY OF THE INVENTION

In view of the shortcomings of the existing technology, the main objective of the present invention is to provide a document processing device and an intuitive operation method thereof. After the document processing device obtains the paper feed information, it provides interactive prompt information in a timely manner, so that the user can intuitively provide command information, and the document processing device automatically executes a document processing mode according to the command information, in order to improve operational efficiency and ease of use.

To achieve the above objective, the main technical means used by the invention is an intuitive operation method of the aforementioned document processing device, which comprises the following steps:
obtaining paper feed information;
providing interactive prompt information, and receiving command information; and
executing a document processing mode according to the command information.

By the above steps, after the document processing device obtains the paper feed information, it provides the interactive prompt information to the user, and the user provides the command information, so that the document processing device executes the document processing mode according to the command information, in order to improve operational efficiency and ease of use.

To achieve the objective, another main technical means used by the invention is the aforementioned document processing device, which comprises:
an input module, obtaining paper feed information;
a human-computer interaction interface; and
a processor, connected to the input module and the human-computer interaction interface;
wherein the processor drives the human-computer interaction interface according to the paper feed information, so that the human-computer interaction interface provides interactive prompt information, and when the human-computer interaction interface receives command information, the processor executes a document processing mode according to the command information.

By the above structure, after the input module of the document processing device obtains the paper feed information, the processor drives the human-computer interaction interface to provide the interactive prompt information to the user, and after the human-computer interaction interface receives the command information provided by the user, the processor makes the document processing device execute the corresponding document processing mode according to the command information, in order to improve the operational efficiency and ease of use.

### BRIEF DESCRIPTION OF THE DRAWINGS

FIG. 1 is a schematic view of the structure of a document processing device of the present disclosure.

FIG. 2 is a schematic flow chart of steps of an intuitive operation method of the document processing device of the present disclosure.

FIG. 3 is another schematic flow chart of steps of the intuitive operation method of the document processing device of the present disclosure.

### DETAILED DESCRIPTION OF THE INVENTION

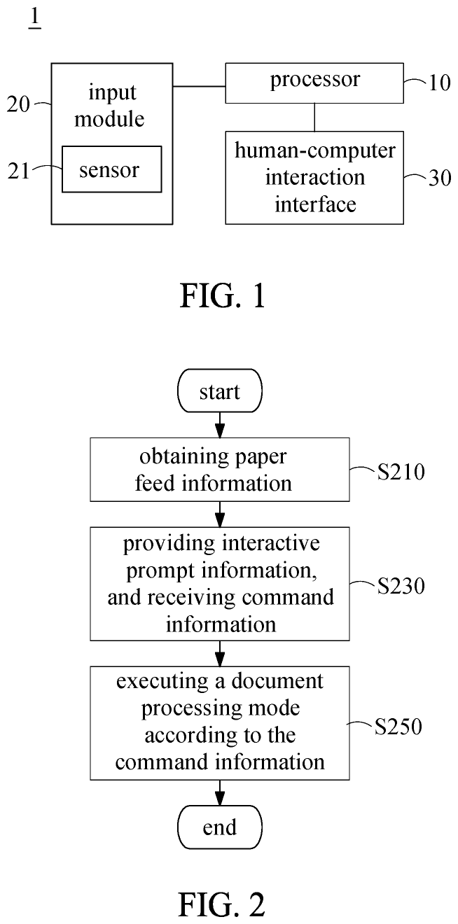

As to a preferable embodiment of a document processing device of the present invention, referring to FIG. 1 to FIG. 3, the document processing device 1 at least comprises a processor 10, an input module 20 and a human-computer interaction interface 30, wherein the processor 10 is electrically connected with the input module 20 and the human-computer interaction interface 30.

The input module 20 is used to sense and obtain paper feed information, and the paper feed information is used to indicate whether a paper has been fed into the input module 20.

The human-computer interaction interface 30 is used to generate interactive prompt information, and a user is prompted and directed to input command information through the interactive prompt information.

The processor 10 is used to drive the human-computer interaction interface 30 according to the paper feed information, so that the human-computer interaction interface 30 actively provides the interactive prompt information, and when the human-computer interaction interface 30 receives the command information inputted by the user, the processor 10 executes a document processing mode according to the command information.

Therefore, when the user feeds the paper into the input module 20, the input module 20 generates the corresponding paper feed information, and the processor 10 drives the human-computer interaction interface 30 according to the paper feed information, so that the human-computer interaction interface 30 actively provides the interactive prompt information, the user can provide the corresponding command information according to the interactive prompt information, so that the processor 10 executes the document processing mode according to the command information.

Thereby, the user only needs to intuitively input the corresponding command information according to the interactive prompt information generated by the human-computer interaction interface 30 neither the need to find the required operation panel nor the need for complicated settings, can quickly make the document processing device 1 automatically carry out the required document processing mode, in order to improve the operational efficiency and ease of use of the document processing device 1.

In the preferable embodiment, the document processing device 1 may be achieved by a scanner or an office equipment, and the present invention is not limited to herein.

In the preferable embodiment, the input module 20 consists of an automatic document feeder (ADF).

In the preferable embodiment, the input module 20 further comprises a sensor 21, which is used to sense whether there is paper fed into the input module 20, and generates the corresponding paper feed information.

In the preferable embodiment, the command information comprises multiple scanning behavior information, such as a front scanning command, a back scanning command or a double-sided scanning command, and the present invention is not limited to herein.

In the preferable embodiment, the interactive prompt information may comprises a start-up prompt information and at least one command prompt information, wherein the start-up prompt information is used to prompt the user to prepare to input the command information with the human-computer interaction interface 30, the command prompt information is used to prompt and guide the user to input the command information.

In the preferable embodiment, the human-computer interaction interface 30 can be achieved by a sound interface, a touch interface and/or a physical interface, and the present invention is not limited to herein. For example, in order to optimize the user's experience of use, the human-computer interaction interface 30 can be achieved by the sound interface, the touch interface or the physical interface, in addition, the human-computer interaction interface 30 can be achieved by the sound interface and the physical interface/the touch interface at the same time. In other words, the human-computer interaction interface 30 is not limited to be achieved by a single interface.

Further, the sound interface may consist of a speaker module and a microphone.

In the preferable embodiment, the sound interface provides the interactive prompt information in the form of a sound information, the sound information may comprise a voice prompt, so that the user can simply complete settings of the document processing mode by inputting the voice prompt to improve the operational efficiency and ease of use of the document processing device 1.

Therefore, in the embodiment of the human-computer interaction interface 30 implemented by the sound interface, when the user feeds the paper into the input module 20, the human-computer interaction interface 30 is thus driven, and actively provides the interactive prompt information as the start-up prompt information (e.g., the speaker module actively plays the voice prompt of “please set”) to prompt the user to prepare for settings of document processing, and then the human-computer interaction interface 30 provides the interactive prompt information of the command prompt information to prompt the user to input the command information (e.g., the speaker module actively plays the voice prompt of “please select front scanning, back scanning or double-sided scanning”), the user can provide the corresponding command information after hearing the interactive prompt information (e.g., input the voice prompt of “front scanning” by the microphone), and after the command information is confirmed to be correct (e.g., the speaker module plays the voice prompt of “selecting front scanning, is it correct or not”, the user inputs the voice prompt of “correct”), the processor 10 makes the document processing device 1 execute the document processing mode according to the command information, that is, executing the document processing mode of the front scanning.

Further, the touch interface may consist of a touch display.

In the preferable embodiment, the touch interface provides the interactive prompt information in the form of an image information, the image information may comprise an option operation screen, so that the user can simply complete settings of the document processing mode by touching and selecting the specific option operation screen generated by the touch interface to improve the operational efficiency and ease of use of the document processing device 1.

Therefore, in the embodiment of the human-computer interaction interface 30 implemented by the touch interface, when the user feeds the paper into the input module 20, the human-computer interaction interface 30 is thus driven, and actively provides the interactive prompt information as the start-up prompt information (e.g., the touch display shows the image information of “please set”) to prompt the user to prepare for settings of document processing, and then the human-computer interaction interface 30 provides the interactive prompt information of the command prompt information to prompt the user to input the command information (e.g., the touch display actively shows the image information of “please select front scanning, back scanning and double-sided scanning”), the user can select the corresponding command information after seeing the interactive prompt information (e.g., touch the image information of “front scanning”), and after the command information is confirmed to be correct (e.g., the touch display shows the image information of “selecting front scanning, is it correct or not”, the user further touches the image information of “correct” showed by the touch display), the processor 10 makes the document processing device 1 execute the document processing mode according to the command information, that is, executing the document processing mode of the front scanning.

Further, the physical interface may consist of multiple LED lights and the corresponding multiple keys.

In the preferable embodiment, the physical interface provides the interactive prompt information in the form of color information, the color information comprises a set of physical lights, so that the user can simply complete settings of the document processing mode by selecting the physical interface to improve the operational efficiency and ease of use of the document processing device 1.

Therefore, in the embodiment of the human-computer interaction interface 30 implemented by the physical interface, when the user feeds the paper into the input module 20, the human-computer interaction interface 30 is thus driven, and actively provides the interactive prompt information as the start-up prompt information (e.g., the LED lights are on at the same time) to prompt the user to prepare for settings of document processing, and then the human-computer interaction interface 30 provides the interactive prompt information of the command prompt information to prompt the user to input the command information (e.g., the LED lights respectively indicating “front scanning”, “back scanning” and “double-sided scanning” twinkle at the same time), the user can select the corresponding command information after seeing the interactive prompt information (e.g., input the command information by pressing the key corresponding to the LED light for the “front scanning”), and after the command information is confirmed to be correct (e.g., make the LED light corresponding to the front scanning twinkle again, and the user presses the key corresponding to the LED light again to input the command information corresponding to “correct”), the processor 10 makes the document processing device 1 execute the document processing mode according to the command information, that is, executing the document processing mode of the front scanning.

The above-mentioned preferable embodiments and application methods of the present invention can be summarized as an intuitive operation method of a document processing device, as shown in FIG. 2, the method is mainly to make the document processing device 1 to execute the following steps:
obtaining paper feed information (S210); in the preferable embodiment, the input module 20 of the document processing device 1 is used to sense and obtain paper feed information, and the paper feed information is used to indicate whether a paper has been fed into the input module 20;
providing interactive prompt information, and receiving command information (S230); in the preferable embodiment, the human-computer interaction interface 30 of the document processing device 1 is used to generate the interactive prompt information, and a user is prompted and directed to input the command information through the interactive prompt information;
executing a document processing mode according to the command information (S250); after the human-computer interaction interface 30 receives the command information, the document processing device 1 executes a document processing mode according to the command information.

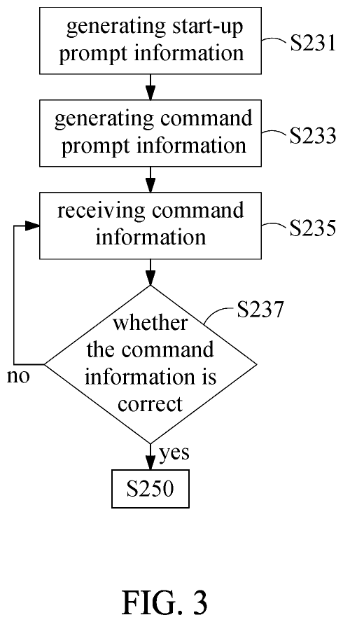

In the preferable embodiment, when the above steps are executed to “providing interactive prompt information, and receiving command information (S230)”, as shown in FIG. 3, the method further includes the following sub-steps:

generating start-up prompt information (S231); in the preferable embodiment, the human-computer interaction interface 30 actively generates the start-up prompt information to prompt the user to prepare to input the command information;

generating command prompt information (S233); in the preferable embodiment, the human-computer interaction interface 30 actively generates the start-up prompt information to prompt the user to prepare to input the command information;

receiving command information (S235); in the preferable embodiment, the user inputs the corresponding command information according to the command prompt information

determining whether the command information is correct (S237); in the preferable embodiment, the human-computer interaction interface 30 generates the interactive prompt information, prompting the user to input the command information to confirm whether the command information inputted in step (S235) is correct, when determined to be correct, to carry out step S250, and vice versa, back to step S235, so that the user inputs the command information again.

In the preferable embodiment, when the human-computer interaction interface 30 is implemented with the sound interface, the start-up prompt information, the command prompt information and the command information are implemented with a voice prompt.

In the preferable embodiment, when the human-computer interaction interface 30 is implemented with the touch interface, the start-up prompt information and the command prompt information are implemented with an image information, and the command information is generated by the image information that is selected by the user's touch.

In the preferable embodiment, when the human-computer interaction interface 30 is implemented with the physical interface, the start-up prompt information and the command prompt information are implemented with color information, and the command information is generated by the keys that are pressed and selected by the user and correspond to the color information.

Thereby, the user only needs to intuitively input the corresponding command information according to the interactive prompt information generated by the human-computer interaction interface 30 neither the need to find the required document processing setting interface, nor the need for complicated settings, can quickly make the document processing device 1 carry out the required document processing mode, in order to improve the operational efficiency and ease of use of the document processing device 1.

What is claimed is:

1. An intuitive operation method of a document processing device, comprising steps:
obtaining paper feed information;
providing interactive prompt information, and receiving command information;
executing a document processing mode according to the command information.

2. The intuitive operation method according to claim 1, wherein the interactive prompt information is in the form of a sound information, an image information or a color information.

3. The intuitive operation method according to claim 2, wherein the sound information comprises a voice prompt, the image information comprises an option operation screen, and the color information comprises a set of physical lights.

4. The intuitive operation method according to claim 1, wherein the command information comprises multiple scanning behavior information.

5. The intuitive operation method according to claim 4, wherein the command information comprises a front scanning command, a back scanning command or a double-sided scanning command.

6. A document processing device, comprising:
an input module, obtaining paper feed information;
a human-computer interaction interface; and
a processor, connected to the input module and the human-computer interaction interface;
wherein the processor drives the human-computer interaction interface according to the paper feed information, so that the human-computer interaction interface provides interactive prompt information, and when the human-computer interaction interface receives command information, the processor executes a document processing mode according to the command information.

7. The document processing device according to claim 6, wherein the command information comprises multiple scanning behavior information.

8. The document processing device according to claim 7, wherein the scanning behavior information comprises a front scanning command, a back scanning command or a double-sided scanning command.

9. The document processing device according to claim 6, wherein the human-computer interaction interface comprises a sound interface, a touch interface or a physical interface.

10. The document processing device according to claim 9, wherein the sound interface consists of a speaker module and a microphone.

11. The document processing device according to claim 10, wherein the sound interface provides the interactive prompt information in the form of a sound information, and the sound information comprises a voice prompt.

12. The document processing device according to claim 9, wherein the touch interface consists of a touch display.

13. The document processing device according to claim 12, wherein the touch interface provides the interactive prompt information in the form of an image information, and the image information comprises an option operation screen.

14. The document processing device according to claim 9, wherein the physical interface consists of multiple LED lights and the corresponding multiple keys.

15. The document processing device according to claim 14, wherein the physical interface provides the interactive prompt information in the form of color information, and the color information comprises a set of physical lights.

16. The document processing device according to claim 6, wherein the document processing device is a scanner or an office equipment.

17. The document processing device according to claim 6, wherein the input module comprises a sensor, which is used to obtain the paper feed information.

18. The document processing device according to claim 6, wherein the input module consists of an automatic document feeder.
